(19) United States
(12) Patent Application Publication
(10) Pub. No.: US 2026/0008222 A1
(43) Pub. Date: Jan. 8, 2026

(54) FILM

(71) Applicant: Innovia Films America, Inc., Winston Salem, NC (US)

(72) Inventors: Carlos Diaz, Winston Salem, NC (US); José Luis Velazquez, Zacapu (MX)

(21) Appl. No.: 19/259,398

(22) Filed: Jul. 3, 2025

Related U.S. Application Data
(60) Provisional application No. 63/668,474, filed on Jul. 8, 2024.

(30) Foreign Application Priority Data
Aug. 6, 2024 (GB) 2411539.6

(51) Int. Cl. B29C 48/21; B29C 48/00; B29C 48/08; B29C 71/00; B29C 71/02; B29K 23/00; B29K 105/00; B29K 505/08; B29L 9/00; B29L 31/00

(52) U.S. Cl. CPC B29C 48/21; B29C 48/0018; B29C 48/08; B29C 71/0081; B29C 2071/022; B29K 2023/12; B29K 2023/16; B29K 2105/0085; B29K 2105/0088; B29K 2505/08; B29K 2995/0022; B29K 2995/0053; B29K 2995/0072; B29K 2995/0081; B29L 2009/00; B29L 2031/744

(57) ABSTRACT

The present invention provides a multi-layer polymeric film comprising a core layer; a first skin layer; and at least one intermediate layer between the core layer and the first skin layer; wherein the at least one intermediate layer comprises a cavitating agent such that it is cavitated; and wherein the first skin layer side of the film exhibits a roughness level (Rz) of greater than 2 μm, measured in accordance with ISO 4287.

This application claims priority from U.S. provisional application No. 63/668,474, filed Jul. 9, 2024; the present application also claims priority from GB application 2411539.6-code A73E, filed Aug. 6, 2024. The entity of the forementioned applications is herein incorporated by reference.

### FIELD

The present application relates to a multi-layer polymeric film, a label comprising said film, an article labelled with said label, a method of making said labelled article and method of identifying fibre tear on the labelled article.

### BACKGROUND

Polymeric films have been widely used in the art in combination with an adhesive, for example a cold glue adhesive, to create labels for application to articles such as glass and plastic containers.

It is important for labels to have sufficient adhesion to the article to which they are attached. This adhesion can mean that the plane of failure when tearing the label from the article is within the label structure itself, rather than within the adhesive layer, thereby causing a fibre tear. A fibre tear is where a polymeric film fails such that there is tearing within the polymeric film, thereby leaving the adhesive residue and some of the film on the bonded article.

The presence of fibre tear can be used to assess the quality of bonding between the substrate and article. Additionally, there are some applications in which a fibre tear is a desired property for the end user, for example to mimic the properties of a paper label.

Cavitating agents are used to create cavitation within one or more layers in a film. Cavitation can have an effect on a wide range of properties, such as the surface roughness, density and/or gloss of the film.

For example, EP1374207 describes a thermoplastic label comprising a first skin layer which comprises a thermoplastic and a first cavitating agent, wherein the first skin layer has a first side and a second side, and the first skin layer is cavitated, wherein the first side of the first skin layer is adapted to be used in contact with a cold glue adhesive. This document details a cavitated core layer and homopolymer skin layer comprising calcium carbonate and teaches that it is necessary to cavitate the layer adjacent to the adhesive.

A further cavitated film is disclosed in US2020376819, which describes a multi-layer film including a core layer, a first intermediate layer disposed on a first side of the core layer, a second intermediate layer disposed on a second side of the core layer, a first skin layer disposed on the first intermediate layer and arranged such that the first intermediate layer is disposed between the core layer and the first skin layer, and a second skin layer disposed on the second intermediate layer and arranged such that the second intermediate layer is disposed between the core layer and the second skin layer, wherein the core layer includes first particles in an amount ranging from about 8 to about 20 wt %, based on the total weight of the core layer, the opacity is about 90 or greater, and the gloss ranges from about 60 to less than about 80. The intermediate layers are used to adhere the skin layer to the core layer to produce a stronger laminate and the film is intended to be smooth and glossy.

WO2011129964 relates to a polymer film coating for use preferably with cold glue labels. The coating includes a filler component and a binder component, at least one of which is hydrophobic, and the coating imparts water resistance and solvent resistance to an adhered label, thereby improving resistance to label removal due to moisture or water contact.

US2021/0197539 relates to an opaque multilayer biaxially oriented polypropylene film comprising at least one vacuole-containing base layer and a printable outer cover layer and an inner matte cover layer, the inner cover layer containing at least two incompatible polymers and having a surface roughness Rz of at least 2.0 μm at a cut-off of 25 μm.

However, there is no consideration provided in any of these documents of how to create fibre tear within a film. Therefore, there remains a need for the provision of a multi-layer film with increased fibre tear.

### SUMMARY

According to a first aspect of the present application, there is provided a multi-layer polymeric film comprising a core layer, a first skin layer and at least one intermediate layer between the core layer and the first skin layer, wherein the at least one intermediate layer comprises a cavitating agent such that it is cavitated and wherein the first skin layer side of the film exhibits a roughness level (Rz) of greater than 2 μm, measured in accordance with ISO 4287.

According to a second aspect of the present application, there is provided a label comprising the multi-layer film discussed above and an adhesive layer on the surface of the first skin layer.

According to a third aspect of the present application, there is provided an article labelled with the label discussed above.

According to a fourth aspect of the present application, there is provided a method for forming a labelled article, comprising:
a. providing an article;
b. providing a label as discussed above;
c. arranging the label such that it overlaps with at least a section of the article; and
d. applying pressure to the label such that the film adheres to the article.

According to a fifth aspect of the present invention, there is provided a method of identifying fibre tear on a labelled article, the method comprising:
a. providing a labelled article discussed above;
b. pulling one side of the label away from the article using force; and
c. identifying whether fibre tear has occurred.

### BRIEF DESCRIPTION OF DRAWINGS

The figures herein are illustrative of non-limiting embodiments of the invention.

FIGS. 1A to 1L illustrate the results of a fibre tear test on Samples A to L respectively,

FIGS. 2A and 2B illustrate the results of a delamination test on films according to Example 1 and Comparative Example 2 respectively, and

FIGS. 3A to 3D illustrate the results of a delamination peeling test on films according to Example 2 and Comparative Examples 3 to 5 respectively.

### DETAILED DESCRIPTION

According to a first aspect of the present application, there is provided a multi-layer polymeric film comprising a core layer, a first skin layer and at least one intermediate layer between the core layer and the first skin layer, wherein the at least one intermediate layer comprises a cavitating agent such that it is cavitated and wherein the first skin layer side of the film exhibits a roughness level (Rz) of greater than 2 μm, measured in accordance with ISO 4287.

It has surprisingly been found that the presence of a cavitating agent in the intermediate layer between the core layer and the first skin layer, in combination with a high roughness on the surface of the first skin layer, creates a film that adheres strongly to an article and demonstrates fibre tear on removal. This increased surface roughness improves the adhesion between the surface of the film and the article to which it is applied via the adhesive.

The surface roughness created by the cavitation can contribute to the roughness of the adjacent skin layer, although this is unlikely to be sufficient to create the necessary surface roughness value alone. If the film surface has a lower surface roughness, it has been found that the surface is too smooth and does not result in sufficient adhesion capabilities.

The inclusion of a cavitating agent in the intermediate layer also provides a weaker layer within the film close to the adhered layer, which helps to ensure that the plane of failure is within the film itself, rather than between the film and the article. This increases the fibre tear capability of the multi-layer film.

The inventors have therefore found that the combination of a rough film surface and cavitation in the intermediate layer between the core layer and the first skin layer is important to achieve the desired fibre tear, as the weaker intermediate layer in combination with an improved adhesion between the film and an article drives internal breakage of the film. In other words, the multi-layer film of the present invention, when used as a label, demonstrates internal breakage that results in increased fibre tear.

This, in particular, is compared to films comprising a cavitating agent in any other layer of the film. For example, a cavitating agent solely in the core layer of the film does not provide the desired fibre tear properties. Alternatively, where a cavitating agent is present on the opposite side of the core layer to the first skin layer, the cavitated layer is too far away from the adhesive to affect the adhesion and/or provide a plane of failure in which fibre tear can occur.

The multi-layer film may comprise at least two layers comprising a cavitating agent such that two layers are cavitated. For example, the intermediate layer and at least one other layer may comprise a cavitating agent.

The core layer may comprise a cavitating agent such that it is cavitated. The presence of a cavitating agent in the core layer has surprisingly been found to further aid internal breakage of the multi-layer film, thereby resulting in a greater percentage of fibre tear.

In embodiments where a cavitating agent is present in at least two layers, the cavitating agent may be the same or may be different.

The cavitating agent may be present in an amount between about 0.5 and 15% by weight, optionally between about 5 and 15% by weight of the cavitated layer, optionally between about 5 and 12% by weight of the cavitated layer.

The cavitating agent may be present in an amount of lower than about 15%, or lower than about 12% by weight of the cavitated layer. The cavitating agent may be present in an amount greater than about 0.5%, or greater than about 5% by weight of the cavitated layer. The percentage of cavitating agent in this range has been found to be particularly advantageous for providing optimum surface roughness to aid adhesion, as well as to provide the necessary degree of cavitation to promote internal failure within the film.

Additionally, it is important to disperse the cavitating agent throughout the polymer layer such that the desired roughness and potential failure points can be achieved over the entire film, without agglomeration or overlapping of cavitation agent particles occurring.

In embodiments where a cavitating agent is present in at least two layers, the cavitating agent may be present in the same percentage by weight in each of the cavitated layers.

In other embodiments where a cavitating agent is present in at least two layers, the cavitating agent may be present in different percentages by weight in each cavitated layer. For example, in embodiments where the cavitating agent is present in at least two layers, the cavitating agent may be present in a first layer in an amount between about 5 and 10%, preferably between about 7 and 10% by weight of the layer and present in a second layer in an amount between about 5 and 10%, preferably between about 5 and 7% by weight of the layer. In this embodiment, the core layer may be the first layer and the intermediate layer may be the second layer. The inventors have found that a cavitating agent present in these ranges in two different layers can provide the optimum roughness, adhesion and fibre tear properties, and avoids the agglomeration of cavitating agents.

If the percentage by weight of cavitating agent is greater than the optimal amount, the layer may contain overlapping cavitation, which can detrimentally affect the surface roughness and the structure of the film. If the percentage by weight of the cavitating agent is less than the optimal amount, then the resulting film may not provide the desired plane of failure for a fibre tear and the surface roughness may be too high.

The cavitating agent average particle size may between about 0.5 μm and 4 μm, between about 0.8 μm and 4 μm, optionally between about 0.8 μm and 3.5 μm, optionally between about 1 μm and 3.5 μm. Preferably, the cavitating agent average particle size is greater than about 0.5 μm, greater than about 0.8 μm, greater than about 0.85 μm, optionally greater than about 1 μm.

It has been found that the larger the average particle size of the cavitating agent, the greater the degree of cavitation within the film. Therefore, the particle size can be tailored to the degree of cavitation required to achieve the desired properties. If the average particle size of the cavitating agent is too small, the resulting cavitation may not provide the desired surface roughness, and therefore the resulting film may not provide the desired plane of failure for a fibre tear.

The cavitating agent may be any suitable cavitating agent in the art, including but not limited to calcium carbonate (CaCO3), polymethyl methacrylate, polyamide 6 (PA6), barium carbonate (BaCO3), aluminium oxide, aluminium sulphate, barium sulphate, magnesium carbonate, silicates such as aluminium silicate (kaolin clay), mica and magnesium silicate (talc), polybutylene terephthalate, and silicon dioxide, as well as combinations thereof.

Preferably, the cavitating agent is selected from at least one of calcium carbonate, polymethyl methacrylate, polyamide 6, polybutylene terephthalate, or a combination thereof. In some embodiments, the cavitating agent is calcium carbonate.

The cavitating agent and the resulting cavitation may contribute to the overall roughness and adhesion properties of the multi-layer film. The inventors have found that an increase in cavitation can result in an increased roughness of the surface of the layer.

One or more layers of the multi-layer film may comprise a polyolefin material. All of the layers of the multi-layer film may comprise a polyolefin material. One or more layers, or all of the layers, may comprise over 70%, preferably over 80% by weight polyolefin. The one or more polyolefins in each layer may be a homopolymer, a copolymer or a terpolymer.

For example, the film may comprise at least one layer of homopolypropylene. The majority of the polyolefin or polymer present in said layer may be homopolypropylene, over 90% of the polyolefin or polymer present in said layer may be homopolypropylene or the only polyolefin or polymer present in said layer may be homopolypropylene.

The core layer and/or the intermediate layer may comprise homopolypropylene. Homopolypropylene may be the only polyolefin or polymer in the core layer and/or the intermediate layer, homopolypropylene may comprise over 90% of the polyolefin or polymer in the layer or homopolypropylene may be the majority polyolefin or polymer in the layer.

The first skin layer may comprise a copolymer, such as a propylene/ethylene copolymer. The first skin layer may comprise a blend of incompatible polymers. This increases the surface roughness and decreases the gloss of the skin layer. The first skin layer may comprise a blend of two or more of a propylene/ethylene copolymer, a polyethylene homopolymer and a propylene homopolymer. The blend may comprise at least 1%, optionally at least 1.5% or at least 2% of each polymer.

The film may be made by any process in the art, including, but not limited to, cast sheet, cast film, or blown film. The film may be mono- or bi-axially oriented. The film may be manufactured on a bubble or a stenter line.

The film may be a variety of thicknesses depending on the application requirements. For example, the thickness of the film may be from about 5 to about 200 μm thick, preferably from about 20 to 100 μm thick, and most preferably from about 40 to about 80 μm thick.

The core layer may be between about 20 and 150 μm thick, between about 30 and 100 μm thick, or between about 50 and 75 μm thick.

The intermediate layer between the core layer and the first skin layer may be between about 1 and 10 μm thick, between about 1 and 5 μm thick, or between about 2 and 4 μm thick.

The first skin layer may be between about 0.2 and 5 μm thick, between about 0.3 and 3 μm thick, or between about 0.5 and 2 μm thick.

The first skin layer may be corona treated. The first skin layer may not be cavitated. The inventors have advantageously found that the film comprising an uncavitated skin layer provides improved fibre tear. Without wishing to be bound by theory, it is thought that cavitation in the skin layer does not create sufficient adhesion to separate layers within the film, and thus, the plane of failure when tearing the label may not provide the desired plane of failure for a fibre tear.

The multi-layer film may comprise a second skin layer on the opposite side of the film to the first skin layer, with at least one intermediate layer between the second skin layer and the core layer. For example, the multi-layer film may comprise a core layer, an intermediate layer on either side thereof and a skin layer on each side of the intermediate layers. The multi-layer film may comprise 5 layers or 7 layers, for example.

The second skin layer may be thicker than the first skin layer. The second skin layer may be between about 0.5 and 5 μm thick, between about 0.8 and 3 μm thick, or between about 1 and 2 μm thick.

The second skin layer may be corona treated. The second skin layer may be high corona treated, while the first skin layer may be low corona treated. This means that the second skin layer is tailored to accept ink while the first skin layer is tailored to accept an adhesive. Treating both sides can also avoid issues with blocking, label dispensing and static issues.

The second skin layer may be formed from a polymer and may be formed from a polyolefin. The polyolefin may be a propylene/ethylene copolymer. The polyolefin may comprise over 90% of the polymer in the second skin layer and the polyolefin may be the only polymer in the second skin layer. The second skin layer may not be cavitated.

The intermediate layer between the second skin layer and the core layer may comprise a polyolefin, which may be a propylene homopolymer. The polyolefin may comprise over 90% of the polymer in the second skin layer and the polyolefin may be the only polymer in the second skin layer.

The first skin layer side of the film may have a lower gloss than the second skin layer side of the film, when measured at 45° and/or 60° in accordance with ASTM D2457. The first skin layer side of the film may have a higher Rz than the second skin layer side of the film. This means that the second skin layer has a glossier finish and accepts print more easily than the first skin layer.

The intermediate layers on each side of the film may be different. For example, the intermediate layer on the first skin layer side of the film may be different to an intermediate layer on the second skin layer side of the film.

The intermediate layer between the second skin layer and the core layer may be absent of a cavitating agent. The presence of a cavitation agent in the intermediate layer has been found to increase the roughness of the surface of the skin film layer it is closest to.

The intermediate layer between the second skin layer and the core layer may be thicker than the intermediate layer between the first skin layer and the core layer. The intermediate layer between the second skin layer and the core layer may be between about 1 and 10 μm thick, between about 2 and 7 μm thick, or between about 3 and 5 μm thick.

The first skin layer side of the film may exhibit a gloss (at) 20° of ≤25, optionally ≤15, and optionally ≤10, measured in accordance with ASTM D2457.

The first skin layer side of the film may exhibit a gloss (at) 45° of ≤50, optionally ≤45, and optionally ≤40, measured in accordance with ASTM D2457. The increased roughness of the first skin layer generally means that it will have a low gloss value, as surface roughness and gloss are inversely correlated.

The first skin layer of the film may exhibit a gloss (at) 60° of ≤50, optionally ≤45, further optionally ≤40, measured in accordance with ASTM D2457.

The first skin layer of the film may exhibit a roughness level (Rz) of greater than 3 μm, optionally greater than 4 μm. The first skin layer of the film may exhibit a roughness level (Rz) of between about 2 and 10 μm, between about 3 and 8 μm, or between about 4 and 6 μm. A surface roughness of between these ranges has been found to promote optimum adhesion and fibre tear properties. The roughness may be measured in accordance with ISO 4287.

The second skin layer of the film may exhibit a gloss (at) 45° of ≤55, optionally ≤50, measured in accordance with ASTM D2457.

The second skin layer of the film may exhibit a gloss (at) 60° of ≤60, optionally ≤55, measured in accordance with ASTM D2457.

The second skin layer of the film may exhibit a roughness level (Rz) of greater than 1 μm, optionally greater than 2 μm. The second skin layer of the film may exhibit a roughness level (Rz) of between about 1 and 8 μm, between about 1 and 5 μm, or between about 2 and 4 μm.

There are various ways in which the surface roughness of a film can be tailored. For example, the roughness of the first skin layer side of the film may be created by internal roughness (i.e., the presence of cavitation and/or particulates in an internal layer of the film), increased surface roughness (e.g. caused by particulates in the skin layer) and/or incompatible polymers in the first skin layer.

The skin layers may be printable, sealable, metallised/metallisable and/or barrier layers (including moisture, oxygen and UV barrier layers). The film may be a three-layer film, a four-layer film, a five-layer film or a seven-layer film. The film structure may be symmetrical around the core layer. Additionally, or alternatively, a coating may be applied after extrusion and orientation of the film.

The film may comprise one or more conventional additives, including antiblocks, slip components (e.g. wax), tack reducing additives (e.g. fumed silica, silica, silicone gum), UV absorbers, dyes, pigments, colorants, fillers, lubricants, cross-linkers, anti-static agents (cationic, anionic and/or non-ionic, e.g. poly-(oxyethylene) sorbitan monooleate), anti-oxidants (e.g. phosphorous acid, tris (2,4-di-tert-butyl phenyl) ester), gloss improvers, prodegradants, additives to improve ink adhesion and/or printability, additives to increase the coefficient of friction (e.g. silicon carbide), additives to increase stiffness (e.g. hydrocarbon resin), and/or additives to increase shrinkage (e.g. hard resin).

The core layer and/or at least one intermediate layer may optionally comprise an opacifying agent. Optionally, the intermediate layer between the core layer and the first skin layer may comprise an opacifying agent and a cavitating agent. The opacifying agent may therefore contribute to the surface roughness of the first skin layer.

The opacifying agent may be any opacifying agent conventionally used, including titanium dioxide, aluminium oxide, aluminium sulphate, barium sulphate, calcium carbonate, magnesium carbonate, silicates (aluminium, magnesium), silicon dioxide and combinations thereof. Titanium dioxide may be used due to its very high refractive index. Preferably, the core layer and/or at least one intermediate layer comprises an opacifying agent. The core and both intermediate layers may comprise an opacifying agent.

The opacifying agent may also act as a pigment and can be chosen to give the desired colour, for example white. Opacifying agents may have an average particle diameter in the range 0.01 to 1 μm, which can provide optimal light scattering (depending on their refractive index). Opacifying agents may have a higher density than the polymer of the film. The cavitation created by the cavitating agent may offset the increase in density caused by the opacifying agent, thereby retaining the desired density of the film overall.

The cavitating agent and the resulting cavitation may also contribute to the opacity of the film. A component is considered a cavitating agent if it creates a void during orientation and an opacifying agent if it contributes to the opacity of the film without creating a void. Generally speaking, an opacifying agent does not have a particle size great enough to form cavities.

The core layer may comprise the majority of the thickness of the film. The core layer may comprise more than 60%, optionally more than 70%, further optionally more than 80% of the thickness of the film. The cavitating agent may be located in the core layer of the film.

The core layer may have a density of less than 0.8 g/cm³, optionally less than 0.7 g/cm3. The core layer, when comprising a cavitating agent, may have a density of between about 0.5 and 0.8 g/cm³, or between about 0.55 and 0.7 g/cm3.

The intermediate layer between the core layer and the first skin layer may have a density of less than 0.85 g/cm³, optionally less than 0.75 g/cm³. The intermediate layer between the core layer and the first skin layer may have a density of between about 0.5 and 0.85 g/cm³, or between about 0.6 and 0.75 g/cm3.

The intermediate layer between the core layer and the first skin layer may have a lower density than an intermediate layer between the core layer and the second skin layer. This may be because the intermediate layer between the core layer and the second skin layer has less or no cavitation. The intermediate layer between the core layer and the second skin layer may have a density of between about 0.8 and 1.2 g/cm³, or between about 0.9 and 1.05 g/cm3.

The skin layer(s) may not contain any cavitation and so may also have a density of higher than the intermediate layer between the core layer and the first skin layer. The skin layer(s) may have a density of between about 0.8 and 1.1 g/cm³, or between about 0.85 and 1 g/cm3.

A density of less than water for the film overall is important during the separation of polymeric films from other materials during recycling.

According to a second aspect of the present application, there is provided a label comprising the multi-layer film discussed above and an adhesive layer on the surface of the first skin layer.

The inventors have found that a label according to the invention exhibits increased fibre tear compared to labels of the art.

The label may comprise print on at least one side thereof. The print may be applied to a second skin layer on the opposite side to the core layer from the first skin layer. In some embodiments, the label may be printed on both sides thereof.

The label may have been cut from the multi-layer film as discussed above. The multi-layer film as discussed above may be die cut to create numerous labels. A liner layer may be present on the opposite side of the adhesive to the multi-layer film. The liner layer may be adhered to multiple labels formed from the same multi-layer film, which may be surrounded by a skeleton matrix portion.

The adhesive layer may cover the whole area of the surface of the first skin layer of the label. The adhesive layer may cover at least 70%, at least 80%, or at least 90% of the surface of the first skin layer of the label.

The adhesive layer may comprise a cold glue adhesive or a roll-fed hot melt. The label may be a hot melt cut and stack label.

The adhesive layer may comprise a water-based emulsion. The water-based emulsion may be selected from at least one of an acrylic-based adhesive or a vinyl acetate ethylene based adhesive. Preferably, the adhesive layer comprises an acrylic-based adhesive.

The adhesive may provide an adhesion force of more than 10N, optionally more than 12N, when measured with a digital force gauge and pull dynamometer tension/pressure tester adapted with a film label grip. The adhesion force may be measured in accordance with ASTM D-903 and ISO 8510-2. This ensures that the plane of failure when removing the label is within the label structure itself, rather than in the plane of the adhesive.

The inventors have found that the use of a water-based emulsion adhesive, in particular an acrylic-based adhesive, provides sufficiently strong adhesion between the multi-layer film and an article. If the adhesion between the multi-layer film and the article is not strong enough, the separation of the two will occur in the plane of the adhesive, with no fibre tear.

According to a third aspect of the present application, there is provided an article labelled with the label discussed above.

The article may be a container or other packaging. For example, the article may be a bottle. The article may comprise a different polymeric material to that in the film or may comprise glass. For example, the multi-layer film may be polyolefinic, while the article may be formed from PET or another material. The label may not contain the material of the article.

The label may extend around the entire perimeter of the article.

The label may partially extend around the perimeter of the article.

Thus, the invention provides a way in which to label or decorate an article, using a multi-layered film that may provide fibre tear when separated from the article.

According to a fourth aspect of the present invention, there is provided a method for forming a labelled article, comprising:
a. providing an article;
b. providing a label as discussed above;
c. arranging the label such that it overlaps with at least a section of the article; and
d. applying pressure to the label such that the film adheres to the article.

The article may be a container or other packaging. For example, the article may be a bottle. The article may comprise a different polymeric material to that in the film, or may comprise glass. For example, the multi-layer film may be polyolefinic, while the article may be formed from PET or another material. The label may not contain the material of the article.

The label may extend around the entire perimeter of the article. The label may partially extend around the perimeter of the article.

This method provides a simple way in which to adhere a label to an article, to create a label that will demonstrate fibre tear when it is removed.

According to a fifth aspect of the present invention, there is provided a method of identifying fibre tear on a labelled article, the method comprising:
a. providing a labelled article discussed above;
b. pulling one side of the label away from the article using force; and
c. identifying whether fibre tear has occurred.

The term “fibre tear” is to be understood as failure of the multilayer film in the plane of the film itself, such that tearing of the films occurs when it is pulled from the article. This means that a residue of the adhesive and some of the film is left on the article.

The force required to pull the label from the article may be at least 10N, optionally more than 12N.

The fibre tear may be measured using the percentage of the area previously covered by the label on which part of the film remains once the label has been removed. This provides a measure of the degree of failure in the plane of the film itself. This percentage may be greater than 30%, optionally greater than 40%, optionally greater than 50%.

Fibre tear may be measured by a manual peel test and the degree of fibre tear may be subjectively evaluated.

The features of any of the above aspects are equally applicable to any of the other aspects in the present application.

The invention will now be more particularly described with reference to the following examples and figures, which are not intended to be limiting on the scope of protection, in which:

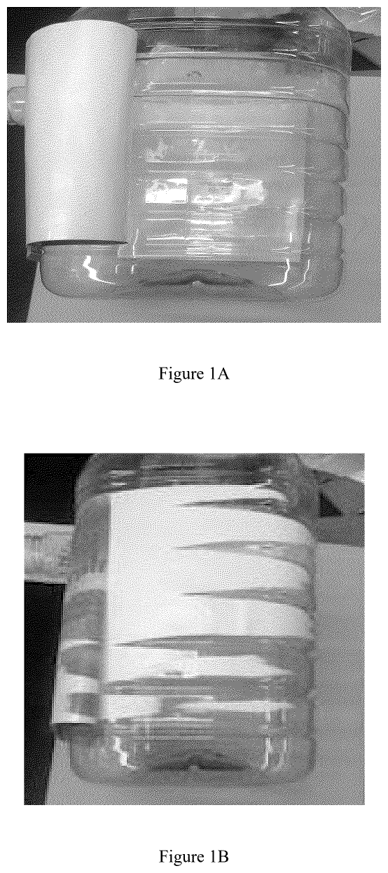

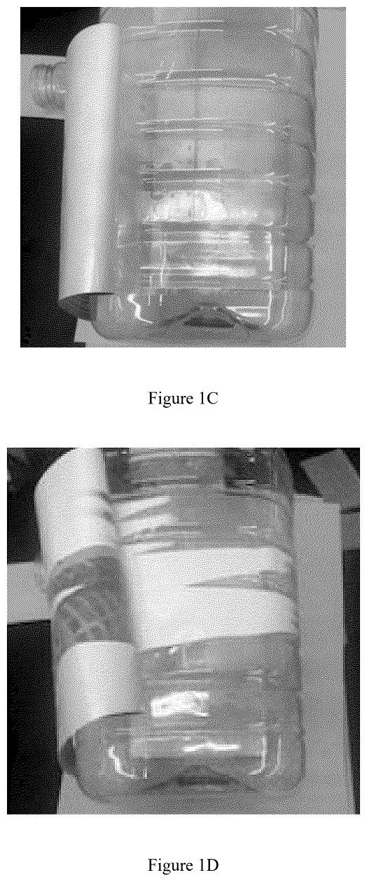

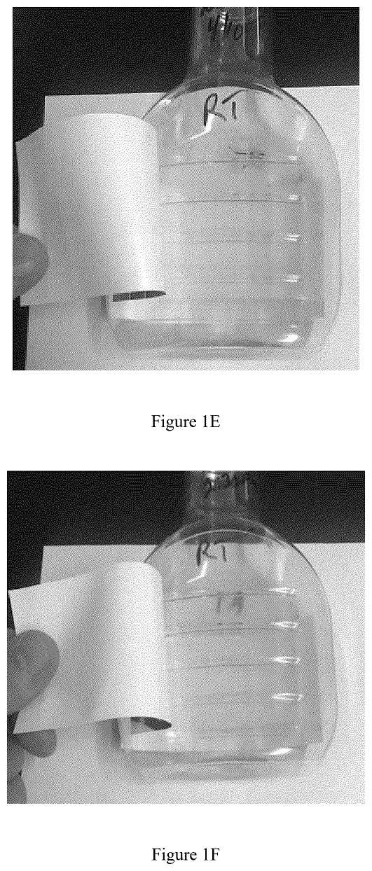

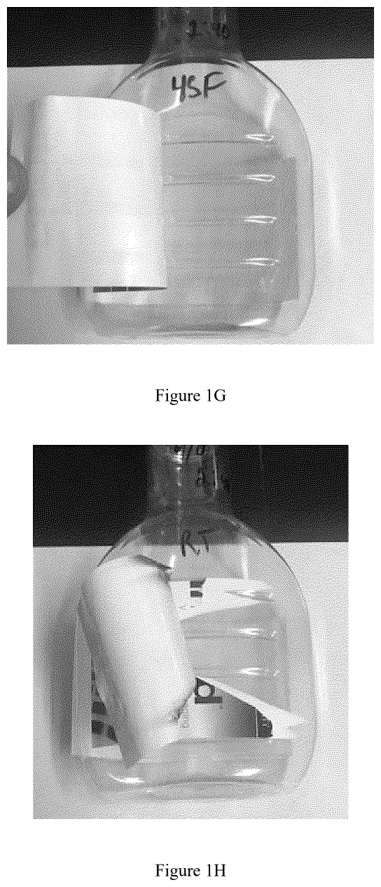

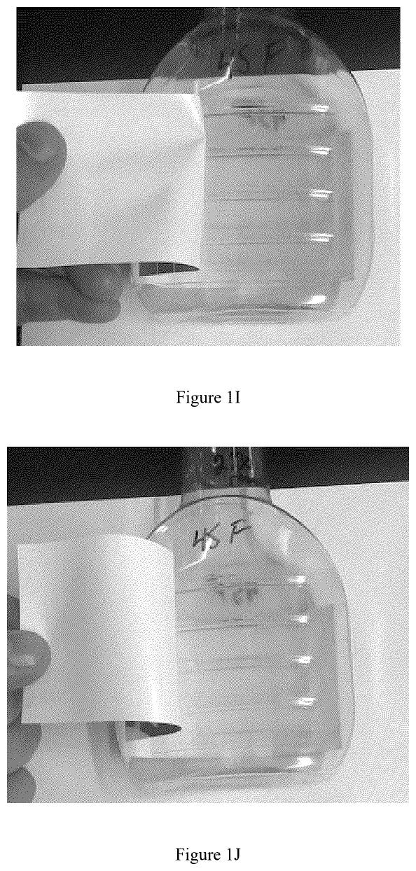

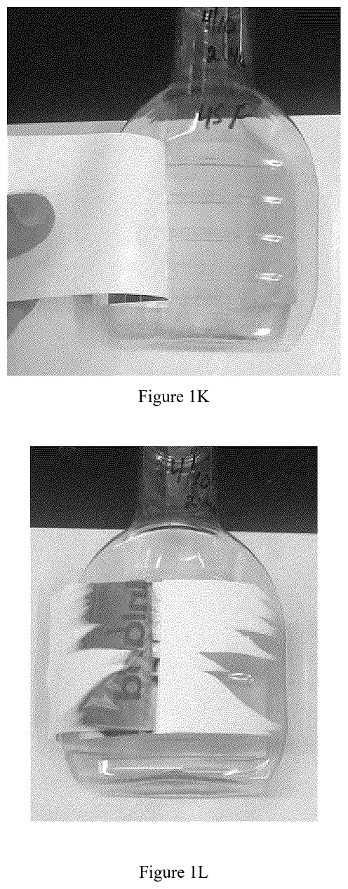

FIGS. 1A to 1L illustrate the results of a fibre tear test on Samples A to L respectively,

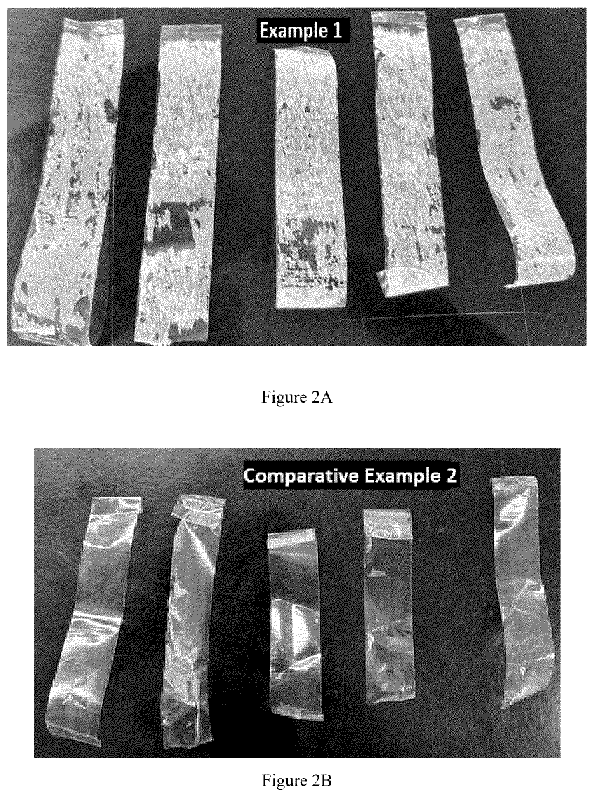

FIGS. 2A and 2B illustrate the results of a delamination test on films according to Example 1 and Comparative Example 2 respectively, and

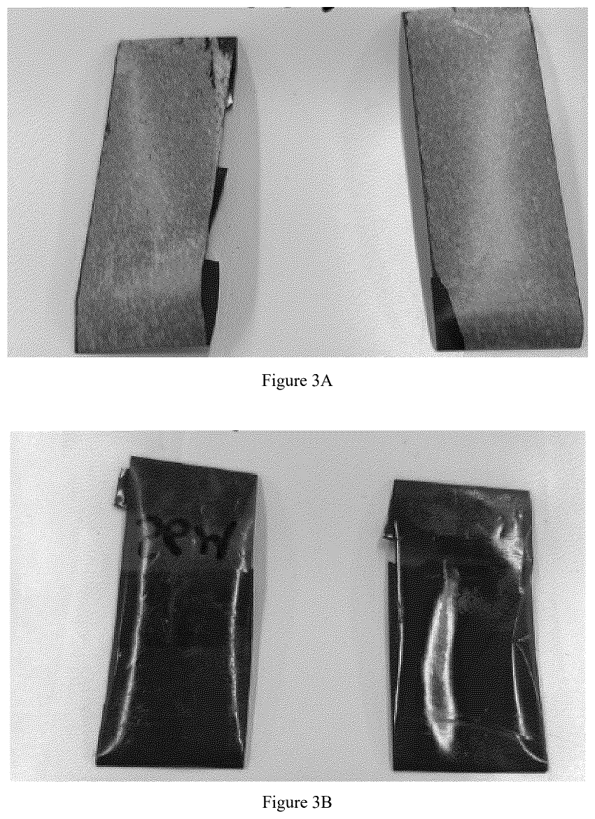

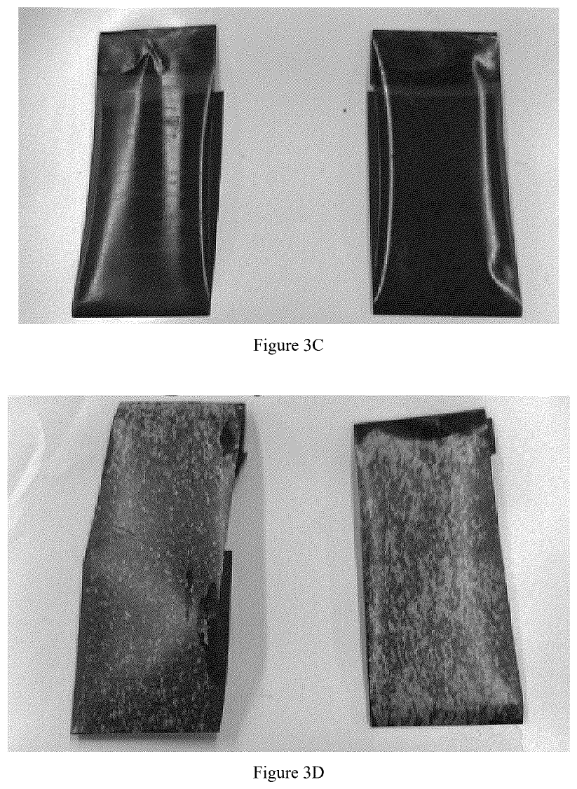

FIGS. 3A to 3D illustrate the results of a delamination peeling test on films according to Example 2 and Comparative Examples 3 to 5 respectively.

### Preparation of Films

### Example 1

Two five-layer films were created, each comprising a core layer, an intermediate layer on each side of the core layer and a skin layer on each of the intermediate layers.

Example 1 is a multi-layer film in accordance with the present invention, in which the intermediate layer and core layer comprise a cavitating agent. The Comparative Example 1 is a multi-layer film comprising a cavitating agent in the core layer of the film, but not in the intermediate layer. The composition of the films is outlined in the tables below. The films were made using a stenter frame film extrusion machine, on which the films were hot stretched in both the machine direction and the transverse direction, before being annealed.

The first skin layer was low corona treated and the second skin layer was high corona treated.

TABLE 1a

| | | % by |
|---|---|---|
| Example 1 | | weight |
| High corona treated | Propylene/ethylene copolymer (99.89% | 98 |
| second skin layer | propylene/ethylene copolymer, 0.11% antioxidant) | |
| (1.4 μm) | Antiblock masterbatch (93% propylene/ethylene | 2 |
| | copolymer, 1.55% propylene homopolymer, 5% organic | |
| | antiblock, 0.45% antioxidant) | |
| Intermediate layer | Polypropylene homopolymer (99% propylene | 81.8 |
| (4 μm) | homopolymer, 1% antioxidant) | |
| | Titanium dioxide masterbatch (37.32% propylene | 17 |
| | homopolymer, 62% TiO₂, 0.68% antioxidant) | |
| | Antistatic masterbatch (94.8% propylene homopolymer, | 1.2 |
| | 5% antistatic, 0.2% antioxidant) | |
| Core layer | Polypropylene homopolymer (99% propylene | 78 |
| (60.8 μm) | homopolymer, 1% antioxidant) | |
| | Titanium dioxide masterbatch (37.32% propylene | 12 |
| | homopolymer, 62% TiO₂, 0.68% antioxidant) | |
| | Calcium Carbonate masterbatch (19.6% propylene | 10 |
| | homopolymer, 80% CaCO₃, 0.4% antioxidant) | |
| Intermediate layer | Polypropylene homopolymer (99% propylene | 80 |
| (3 μm) | homopolymer, 1% antioxidant) | |
| | Titanium dioxide masterbatch (37.32% propylene | 10 |
| | homopolymer, 62% TiO₂, 0.68% antioxidant) | |
| | Calcium Carbonate masterbatch (19.6% propylene | 8 |
| | homopolymer, 80% CaCO₃, 0.4% antioxidant) | |
| | Antistatic masterbatch (94.8% propylene homopolymer, | 2 |
| | 5% antistatic, 0.2% antioxidant) | |
| Low corona treated | Propylene/ethylene copolymer (99.89% | 87.6 |
| first skin layer | propylene/ethylene copolymer, 0.11% antioxidant) | |
| (0.8 μm) | Polyethylene homopolymer (99.83% ethylene | 2 |
| | homopolymer, 0.17% antioxidant) | |
| | Organic antiblock masterbatch (93% propylene/ethylene | 10 |
| | copolymer, 1.55% propylene homopolymer, 5% organic | |
| | antiblock, 0.45% antioxidant) | |
| | Antioxidant masterbatch (93.8% propylene | 0.4 |
| | homopolymer, 6.2% antioxidant) | |

TABLE 1b

| | | % by |
|---|---|---|
| Comparative Example 1 | | weight |
| High corona treated | Propylene/ethylene copolymer (99.89% | 55.8 |
| second skin layer | propylene/ethylene copolymer, 0.11% antioxidant) | |
| (2.3 μm) | Polyethylene homopolymer (99.83% polyethylene | 40 |
| | homopolymer, 0.17% antioxidant) | |
| | Antiblock masterbatch (93% propylene/ethylene | 1.2 |
| | copolymer, 1.55% propylene homopolymer, 5% organic | |
| | antiblock, 0.45% antioxidant) | |
| | Antioxidant masterbatch (93.8% propylene | 3.0 |
| | homopolymer, 6.2% antioxidant) | |
| Intermediate layer | Polypropylene homopolymer (99% propylene | 98.8 |
| (5.3 μm) | homopolymer, 1% antioxidant) | |
| | Antistatic masterbatch (94.8% propylene homopolymer, | 1.2 |
| | 5% antistatic, 0.2% antioxidant) | |
| Core layer | Polypropylene homopolymer (99% propylene | 75 |
| (54.1 μm) | homopolymer, 1% antioxidant) | |
| | Titanium dioxide masterbatch (37.32% propylene | 8 |
| | homopolymer, 62% TiO₂, 0.68% antioxidant) | |
| | Calcium Carbonate masterbatch (19.6% propylene | 16 |
| | homopolymer, 80% CaCO₃, 0.4% antioxidant) | |
| | Slip/Antistatic masterbatch (84.8% propylene | 1 |
| | homopolymer, 6% antistatic, 5% slip additive, 4% | |
| | antistatic, 0.05% antioxidant, 0.15% antioxidant) | |
| Intermediate layer | Polypropylene homopolymer (99% propylene | 98.8 |
| (5.3 μm) | homopolymer, 1% antioxidant) | |
| | Antistatic masterbatch (94.8% propylene homopolymer, | 1.2 |
| | 5% antistatic, 0.2% antioxidant) | |
| Low corona treated | Propylene/ethylene copolymer (99.89% | 54.6 |
| first skin layer | propylene/ethylene copolymer, 0.11% antioxidant) | |
| (3 μm) | Polyethylene homopolymer (99.83% ethylene | 35 |
| | homopolymer, 0.17% antioxidant) | |
| | Organic antiblock masterbatch (93% propylene/ethylene | 5.9 |
| | copolymer, 1.55% propylene homopolymer, 5% organic | |
| | antiblock, 0.45% antioxidant) | |
| | Inorganic antiblock masterbatch (94.3% | 1.5 |
| | propylene/ethylene copolymer, 5% inorganic antiblock, | |
| | 0.5% lubricant, 0.13% antioxidant, 0.07% antioxidant) | |
| | Antioxidant masterbatch (93.8% propylene | 3 |
| | homopolymer, 6.2% antioxidant) | |

### Gloss

Gloss measurements of Example 1, and Comparative Example 1 were taken based on ASTM D2457. Gloss results were recorded at both 45° or 60° using a calibrated unit either using a Novo-gloss Lite unit calibrated to a zero reference and then set on a black background of known reflectance or a NovoGloss 45° Rhopoint meter. The unit is regularly tested against both the supplied calibrated block and the background to black sheet. Results are taken over a sample and reported as an average of three tests in Table 2.

TABLE 2

| | Example 1 | | Comparative Example 1 | |
|---|---|---|---|---|
| | First Skin | Second Skin | First Skin | Second Skin |
| Film | Layer | Layer | Layer | Layer |
| Gloss (at 45°) | 37 | 46 | 19 | 18 |
| Gloss (at 60°) | 39 | 50 | 17 | 16 |

It will be seen from Table 2 that the first skin layer of Example 1 exhibits a significantly lower gloss value than the second skin layer. This is due to the presence of incompatible polymers in the first skin layer, as well as the cavitation in the intermediate layer adjacent the first skin layer, both of which affect the surface roughness and therefore the gloss.

### Roughness

Roughness measurements were taken on a Mitutoyo SJ-210 Profilometer based on ISO 4287. Results were taken over a sample film and reported as an average of three tests. The Ra, Rq and Rx measurements were taken and are summarised in Table 3.

TABLE 3

| | Example 1 | | Comparative Example 1 | |
|---|---|---|---|---|
| | First Skin | Second Skin | First Skin | Second Skin |
| Film | Layer | Layer | Layer | Layer |
| Ra (μm) | 0.471 | 0.308 | 0.593 | 0.622 |
| Rq (μm) | 0.608 | 0.396 | 0.732 | 0.774 |
| Rz (μm) | 4.150 | 2.560 | 4.079 | 4.387 |

It will be seen from Table 3 that the first skin layer of Example 1 has a significantly greater Rz value compared to the second skin layer of Example 1, as a result of the cavitating agent being present in the intermediate layer between the core layer and first outer layer, as well as the inclusion of incompatible polymers in the first skin layer.

### Fibre Tear

Various samples were cut and the articles were cleaned with a cloth and alcohol prior to placing the cut sample onto the article. In this example, the articles were bottles made from PET.

An adhesive was applied to the first skin layer of the label (i.e., the low corona treated side) using a glue applicator and roller to ensure uniform application and placed on the article. Different adhesives were tested and these are summarised in Table 4 below. The labelled PET bottles were left to dry for a period of 4 or 5 days at room temperature (RT) (20° C.) or in the fridge (7° C.). The label was then removed from the PET bottle to determine the adhesive force required to remove the label and to identify whether fibre tear occurred. The adhesive force was measured with a digital force gauge and pull dynamometer tension/pressure tester adapted with a film label grip, according to ASTM D-903 and ISO 8510-2. Fibre tear was visually identified.

FIGS. 1a to 1l illustrate the results of a fibre tear test for films A to L respectively.

TABLE 4

| | | | Temper- | Drying | Force/ | Fibre |
|---|---|---|---|---|---|---|
| Sample | Adhesive | Film | ature | Time | N | Tear |
| A | Acrylic- | Comparative | RT | 5 days | 19.1 | No |
| | based | Example 1 | | | | |
| B | Acrylic- | Example 1 | RT | 5 days | 16.0 | Yes |
| | based | | | | | |
| C | Acrylic- | Comparative | Fridge | 5 days | 10.7 | No |
| | based | Example 1 | | | | |
| D | Acrylic- | Example 1 | Fridge | 5 days | 13.5 | Yes |
| | based | | | | | |
| E | Vinyl- | Comparative | RT | 4 days | 8.0 | No |
| | acetate | Example 1 | | | | |
| | ethylene | | | | | |
| | based | | | | | |
| F | Vinyl- | Example 1 | RT | 4 days | 9.1 | No |
| | acetate | | | | | |
| | ethylene | | | | | |
| | based | | | | | |
| G | Acrylic- | Comparative | RT | 4 days | 14.6 | No |
| | based | Example 1 | | | | |
| H | Acrylic- | Example 1 | RT | 4 days | 18.9 | Yes |
| | based | | | | | |
| I | Vinyl- | Comparative | Fridge | 4 days | 3.4 | No |
| | acetate | Example 1 | | | | |
| | ethylene | | | | | |
| | based | | | | | |
| J | Vinyl- | Example 1 | Fridge | 4 days | 2.4 | No |
| | acetate | | | | | |
| | ethylene | | | | | |
| | based | | | | | |
| K | Acrylic- | Comparative | Fridge | 4 days | 9.8 | No |
| | based | Example 1 | | | | |
| L | Acrylic- | Example 1 | Fridge | 4 days | 16.6 | Yes |
| | based | | | | | |

Table 4 and FIGS. 1A to 1L demonstrate that fibre tear is seen (i.e., at least a portion of film remains on the PET bottle) in most of the samples containing the film of Example 1, but none of the samples containing the film of Comparative Example 1.

The only samples where fibre tear was not seen in a sample containing the film of Example 1 is where the adhesion to the bottle was too weak, as demonstrated by the low adhesive force. In these cases, the weak adhesion meant that the plane of failure was in the adhesive layer rather than within the film itself. Specifically, samples F and J did not show a fibre tear because the adhesive force was too low. In contrast, samples B, D, H and L all had higher adhesive force and did demonstrate a fibre tear.

However, samples containing the film of Comparative Example 1 did not demonstrate a fibre tear, even when the adhesive force was high. For example, sample A has the highest adhesive force of any of the samples and still did not demonstrate a fibre tear. In comparison, sample B was prepared under the same conditions and with the same adhesive. However, this sample did demonstrate fibre tear, despite having a lower adhesive force than sample A.

Thus, the presence of a cavitated intermediate layer is important in allowing fibre tear to occur, as long as the adhesion to the article is sufficiently strong.

As shown in Table 3, the roughness of the first surface layer is similar for both Example 1 and Comparative Example 1. Both films are therefore expected to demonstrate a good adhesion, which is generally seen in Table 4. However, for fibre tear to be seen, both a high surface roughness and a cavitated intermediate layer are required.

It can be seen that the conditions of the labelled article (i.e., drying time and temperature) did not affect whether fibre tear occurred. Instead, as long as the adhesive force was sufficiently high, the determining factor was the presence of cavitation in the intermediate layer.

### Example 2

Five samples from the film of Example 1 were stuck to a Scotch® 610 tape and the peelability tested according to Method “ISO-11339:20109 (E) Adhesives T-Peel test for flexible to flexible bonded assemblies”, along with five samples of the film according to Comparative Example 2, the structure of which is outlined below. Comparative Example 2 is a high gloss and low surface roughness film, with a thickness of 60 μm.

TABLE 5

| | | % by |
|---|---|---|
| Comparative Example 2 | | weight |
| High corona treated second | Propylene/ethylene copolymer | 97.5 |
| skin layer (1.2-1.4 μm) | Inorganic antiblock masterbatch | 2.5 |
| Intermediate layer (3-3.5 μm) | Propylene homopolymer | 90 |
| | Titanium dioxide masterbatch | 10 |
| Core layer | Propylene homopolymer | 73.4 |
| | Reclaim material | 18.3 |
| | Organic cavitant masterbatch | 7 |
| | Titanium dioxide masterbatch | 1.3 |
| Intermediate layer (3-3.5 μm) | Propylene homopolymer | 100 |
| Low corona treated first skin | Propylene/ethylene copolymer | 91 |
| layer (1.1-1.3 μm) | Inorganic antiblock masterbatch | 7 |
| | Organic antiblock masterbatch | 2 |

TABLE 6

Comparative Example 2

| Film | First Skin Layer | Second Skin Layer |
|---|---|---|
| Gloss (at 45°) | 102 | 61 |
| Gloss (at 60°) | 109 | 82 |
| Ra (μm) | 0.2 | 0.15 |
| Rq (μm) | 0.24 | 0.19 |
| Rz (μm) | 1.37 | 1.35 |

It was confirmed that all of the samples were firmly stuck to the tape, before each sample was removed by peeling quickly from one end thereof.

The films were placed on a black surface and inspected to identify any delamination within the film. The results are shown in FIGS. 2A and 2B.

As shown in these figures, the films according to Example 1 all demonstrated significant delamination across the area of the films. In contrast, no delamination was seen on any of the samples from Comparative Example 2.

### Example 3

Five samples from the film of Comparative Examples 3, 4 and 5 were tested for their gloss measurements and roughness, their structures of which are outlined below in Tables 7, 8 and 9 respectively. The films were prepared in the same way as outlined in Example 1.

Comparative Example 3 is a multi-layer film, in which an intermediate and core layer comprise a cavitating agent. The film is a high gloss, low surface roughness film.

Comparative Example 4 is a multi-layer film, in which an intermediate and core layers comprise a cavitating agent. The film is a high gloss, low surface roughness film.

Comparative Example 5 is a multi-layer film comprising a cavitating agent in the first skin layer, intermediate layer and the core layer of the film. The structure is outline in Table 9 below.

TABLE 7

| | | % by |
|---|---|---|
| Comparative Example 3 | | weight |
| High corona treated | Propylene/ethylene copolymer (99.89% | 98 |
| second skin layer | propylene/ethylene copolymer, 0.11% antioxidant) | |
| (1.4 μm) | Antiblock masterbatch (93% propylene/ethylene | 2 |
| | copolymer, 1.55% propylene homopolymer, 5% organic | |
| | antiblock, 0.45% antioxidant) | |
| Intermediate layer | Polypropylene homopolymer (99% propylene | 81.8 |
| (4 μm) | homopolymer, 1% antioxidant) | |
| | Titanium dioxide masterbatch (37.32% propylene | 17 |
| | homopolymer, 62% TiO₂, 0.68% antioxidant) | |
| | Antistatic masterbatch (94.8% propylene homopolymer, | 1.2 |
| | 5% antistatic, 0.2% antioxidant) | |
| Core layer | Polypropylene homopolymer (99% propylene | 78 |
| (60.8 μm) | homopolymer, 1% antioxidant) | |
| | Titanium dioxide masterbatch (37.32% propylene | 12 |
| | homopolymer, 62% TiO₂, 0.68% antioxidant) | |
| | Calcium Carbonate masterbatch (19.6% propylene | 10 |
| | homopolymer, 80% CaCO₃, 0.4% antioxidant) | |
| Intermediate layer | Polypropylene homopolymer (99% propylene | 80 |
| (3 μm) | homopolymer, 1% antioxidant) | |
| | Titanium dioxide masterbatch (37.32% propylene | 10 |
| | homopolymer, 62% TiO₂, 0.68% antioxidant) | |
| | Calcium Carbonate masterbatch (19.6% propylene | 8 |
| | homopolymer, 80% CaCO₃, 0.4% antioxidant) | |
| | Antistatic masterbatch (94.8% propylene homopolymer, | 2 |
| | 5% antistatic, 0.2% antioxidant) | |
| Low corona treated | Propylene/ethylene copolymer (99.80% | 89.6 |
| first skin layer | propylene/ethylene copolymer, 0.20% antioxidant) | |
| (3 μm) | Organic antiblock masterbatch (93% propylene/ethylene | 10 |
| | copolymer, 1.55% propylene homopolymer, 5% organic | |
| | antiblock, 0.45% antioxidant) | |
| | Antioxidant masterbatch (93.8% propylene | 0.4 |
| | homopolymer, 6.2% antioxidant) | |

TABLE 8

| | | % by |
|---|---|---|
| Comparative Example 4 | | weight |
| High corona treated | Propylene/ethylene copolymer (99.89% | 98 |
| second skin layer | propylene/ethylene copolymer, 0.11% antioxidant) | |
| (1.4 μm) | Antiblock masterbatch (93% propylene/ethylene | 2 |
| | copolymer, 1.55% propylene homopolymer, 5% organic | |
| | antiblock, 0.45% antioxidant) | |
| Intermediate layer | Polypropylene homopolymer (99% propylene | 81.8 |
| (4 μm) | homopolymer, 1% antioxidant) | |
| | Titanium dioxide masterbatch (37.32% propylene | 17 |
| | homopolymer, 62% TiO₂, 0.68% antioxidant) | |
| | Antistatic masterbatch (94.8% propylene homopolymer, | 1.2 |
| | 5% antistatic, 0.2% antioxidant) | |
| Core layer | Polypropylene homopolymer (99% propylene | 78 |
| (60.8 μm) | homopolymer, 1% antioxidant) | |
| | Titanium dioxide masterbatch (37.32% propylene | 12 |
| | homopolymer, 62% TiO₂, 0.68% antioxidant) | |
| | Calcium Carbonate masterbatch (19.6% propylene | 10 |
| | homopolymer, 80% CaCO₃, 0.4% antioxidant) | |
| Intermediate layer | Polypropylene homopolymer (99% propylene | 80 |
| (3 μm) | homopolymer, 1% antioxidant) | |
| | Titanium dioxide masterbatch (37.32% propylene | 10 |
| | homopolymer, 62% TiO₂, 0.68% antioxidant) | |
| | Calcium Carbonate masterbatch (19.6% propylene | 8 |
| | homopolymer, 80% CaCO₃, 0.4% antioxidant) | |
| | Antistatic masterbatch (94.8% propylene homopolymer, | 2 |
| | 5% antistatic, 0.2% antioxidant) | |
| Low corona treated | Polypropylene homopolymer (99.82% propylene | 89.6 |
| first skin layer | homopolymer, 0.18% antioxidant) | |
| (3.0 μm) | Organic antiblock masterbatch (93% propylene/ethylene | 10 |
| | copolymer, 1.55% propylene homopolymer, 5% organic | |
| | antiblock, 0.45% antioxidant) | |
| | Antioxidant masterbatch (93.8% propylene | 0.4 |
| | homopolymer, 6.2% antioxidant) | |

TABLE 9

| | | % by |
|---|---|---|
| Comparative Example 5 | | weight |
| High corona treated | Propylene/ethylene copolymer (99.89% | 98 |
| second skin layer | propylene/ethylene copolymer, 0.11% antioxidant) | |
| (1.4 μm) | Antiblock masterbatch (93% propylene/ethylene | 2 |
| | copolymer, 1.55% propylene homopolymer, 5% organic | |
| | antiblock, 0.45% antioxidant) | |
| Intermediate layer | Polypropylene homopolymer (99% propylene | 81.8 |
| (4-4.5 μm) | homopolymer, 1% antioxidant) | |
| | Titanium dioxide masterbatch (37.32% propylene | 17 |
| | homopolymer, 62% TiO₂, 0.68% antioxidant) | |
| | Antistatic masterbatch (94.8% propylene homopolymer, | 1.2 |
| | 5% antistatic, 0.2% antioxidant) | |
| Core layer | Polypropylene homopolymer (99% propylene | 78 |
| (60.8 μm) | homopolymer, 1% antioxidant) | |
| | Titanium dioxide masterbatch (37.32% propylene | 12 |
| | homopolymer, 62% TiO₂, 0.68% antioxidant) | |
| | Calcium Carbonate masterbatch (19.6% propylene | 10 |
| | homopolymer, 80% CaCO3, 0.4% antioxidant) | |
| Intermediate layer | Polypropylene homopolymer (99% propylene | 80 |
| (3-3.5 μm) | homopolymer, 1% antioxidant) | |
| | Titanium dioxide masterbatch (37.32% propylene | 10 |
| | homopolymer, 62% TiO₂, 0.68% antioxidant) | |
| | Calcium Carbonate masterbatch (19.6% propylene | 8 |
| | homopolymer, 80% CaCO3, 0.4% antioxidant) | |
| | Antistatic masterbatch (94.8% propylene homopolymer, | 2 |
| | 5% antistatic, 0.2% antioxidant) | |
| Low corona treated | Propylene/ethylene copolymer (99.89% | 84.6 |
| first skin layer | propylene/ethylene copolymer, 0.11% antioxidant) | |
| (3 μm) | Calcium Carbonate masterbatch (19.6% propylene | 5 |
| | homopolymer, 80% CaCO3, 0.4% antioxidant) | |
| | Antioxidant masterbatch (93.8% propylene | 0.4 |
| | homopolymer, 6.2% antioxidant) | |
| | Organic antiblock masterbatch (93% propylene/ethylene | 10 |
| | copolymer, 1.55% propylene homopolymer, 5% organic | |
| | antiblock, 0.45% antioxidant) | |

The samples were tested for their gloss measurements, roughness, the results of which are summarized in Table 10 below, in addition to the results from Example 1 and Comparative Examples 1 and 2.

TABLE 10

| | Gloss | | | | Roughness | | | | | |
|---|---|---|---|---|---|---|---|---|---|---|
| | First Skin Layer | | Second Skin Layer | | First Skin Layer | | | Second Skin Layer | | |
| | Gloss | Gloss | Gloss | Gloss | Ra | Rq | Rz | Ra | Rq | Rz |
| Film | (at 45°) | (at 60°) | (at 45°) | (at 60°) | (μm) | (μm) | (μm) | (μm) | (μm) | (μm) |
| Example 1 | 37 | 39 | 46 | 50 | 0.47 | 0.61 | 4.150 | 0.31 | 0.40 | 2.56 |
| Comparative | 19 | 17 | 18 | 16 | 0.59 | 0.73 | 4.079 | 0.62 | 0.77 | 4.39 |
| Example 1 | | | | | | | | | | |
| Comparative | 102 | 109 | 61 | 82 | 0.20 | 0.24 | 1.37 | 0.15 | 0.19 | 1.35 |
| Example 2 | | | | | | | | | | |
| Comparative | 51.6 | 55.9 | 56.1 | 76.1 | 0.54 | 0.65 | 2.64 | 0.18 | 0.24 | 1.19 |
| Example 3 | | | | | | | | | | |
| Comparative | 55.9 | 81.8 | 56.9 | 76.7 | 0.30 | 0.37 | 1.57 | 0.18 | 0.23 | 1.15 |
| Example 4 | | | | | | | | | | |
| Comparative | 38.6 | 30.5 | 54.2 | 75.9 | 0.64 | 0.77 | 3.11 | 0.22 | 0.28 | 1.36 |
| Example 5 | | | | | | | | | | |

It will be seen from Table 10 that the first skin layer of Example 1 exhibits a significantly lower gloss value than the second skin layer. This is due to the presence of incompatible polymers in the first skin layer, as well as the cavitation in the intermediate layer adjacent the first skin layer, both of which affect the surface roughness and therefore the gloss.

It can be seen that the first skin layer of Comparative Example 2 has a significantly high gloss value than Example 1. This is because the film is a high gloss film, with cavitation only present in the core layer of the film, and therefore the skin layer of the film does not have a high roughness.

Looking at Comparative Examples 3 and 4, these are high gloss films that include cavitation in both the intermediate and core layer of the multi-layer film. Therefore, the gloss value is lower than that of Comparative Example 2, which has only cavitation in the core layer, but lower than Example 1, which has incompatible polymers in the first skin layer, as well as the cavitation in the intermediate layer adjacent the first skin layer.

Comparative Example 5 has a cavitating agent in the first skin layer, the intermediate layer and the core layer of the film and therefore exhibits the lowest gloss value.

Turning to roughness, it can be seen that the first skin layer of Example 1 has a significantly greater Rz value compared to the second skin layer of Example 1, as a result of the cavitating agent being present in the intermediate layer between the core layer and first outer layer, as well as the inclusion of incompatible polymers in the first skin layer.

Comparative Examples 2, 3 and 4 are high gloss films with a low surface roughness, and therefore have the lowest Rz values. Comparative Example 5 has a cavitating agent present in the first skin layer, the core layer, and intermediate layer between the core layer and first outer layer and therefore the first skin layer has a higher Rz value that Comparative Examples 2 to 4.

### Peeling Test

The film of Example 2 is the same structure and composition of Example 1, and is prepared in the same way.

Samples from the film of Example 2, and Comparative Examples 3 to 5, were stuck to a Scotch 610 tape and the peelability was tested according to Method “ISO-11339:20109 (E) Adhesives T-Peel test for flexible to flexible bonded assemblies” and Instron 3343 mechanical testing systems were used.

A 200 m sample of the tape Scotch® 610 was taken. Approximately 15 mm of one end of the tape sample was folded (adhesive to adhesive) and the tape places on top of the film sample to be tested (tape adhesive to film). Pressure was applied to the tape in a lengthwise direction using a roll or by hand to ensure that there was no air between the adhesive and film sample. A lab guillotine was then used to cut a strip of tape-film 15 mm wide to be tested on the mechanical testing system. A summary of the results can be found in Table 11 below, in addition to FIGS. 3a to 3d. Fibre tear was then visually identified.

TABLE 11

| | Peeling Test (20 cm/min) | | |
|---|---|---|---|
| | Maximum force | Average Force 2- | |
| Film | (N/15 mm) | 15 mm (N/15 mm) | Fibre Tear |
| Example 2 | 2.7 | 2.3 | Yes |
| Comparative | 4.7 | 2.5 | No |
| Example 3 | | | |
| Comparative | 3.2 | 2.0 | No |
| Example 4 | | | |
| Comparative | 2.2 | 1.7 | No |
| Example 5 | | | |

Table 11 and FIG. 3a demonstrate significant delamination across the area of the films and fibre tear is seen. For Comparative Examples 3 and 4 (FIGS. 3b and 3c) it can be readily seen that fibre tear did not occur and no delamination was seen.

Looking at Comparative Example 5 (FIG. 3d), it shows that minimal delamination has occurred with a very low average force. This is as a result of the skin layer comprising cavitation, which creates a weak skin layer. For Comparative Example 5, the calcium carbonate particles are exposed to the surface and therefore the bond strength of the adhesive to the film surface is weak. Any tearing seen in FIG. 3d is as a result of the removal of small pieces of the film itself, and not as a result of fibre tear. Thus, no fibre tear has occurred in FIG. 3d. Therefore, for fibre tear to be seen, both a high surface roughness and a cavitated intermediate layer are required.

The above description is for the purpose of teaching the person of ordinary skill in the art how to practice the object of the present application, and it is not intended to detail all those obvious modifications and variations of it which will become apparent to the skilled worker upon reading the description. It is intended, however, that all such obvious modifications and variations be included within the scope of the present application, which is defined by the following claims. The aspects and embodiments are intended to cover the components and steps in any sequence, which is effective to meet the objectives there intended, unless the context specifically indicates the contrary.

What is claimed is:

1. A multi-layer polymeric film comprising:
a core layer;
a first skin layer; and
at least one intermediate layer between the core layer and the first skin layer;
wherein the at least one intermediate layer comprises a cavitating agent such that it is cavitated; and
wherein the first skin layer side of the film exhibits a roughness level (Rz) of greater than 2 μm, measured in accordance with ISO 4287.

2. The multi-layer film according to claim 1 wherein the core layer comprises a cavitating agent such that it is cavitated.

3. The multi-layer film according to claim 1 or claim 2 wherein the cavitating agent is present in an amount between about 0.5 and 15% by weight, optionally between about 5 and 12% by weight of the cavitated layer.

4. The multi-layer film according to any one of claims 1 to 3 wherein the cavitating agent particle size is between about 0.5 and 4 μm, optionally between about 1 and 3.5 μm.

5. The multi-layer film according to any one of claims 1 to 4 wherein the cavitating agent is selected from at least one of calcium carbonate, polymethyl methacrylate (PMMA), polyamide 6 (PA6), polybutylene terephthalate, or a combination thereof.

6. The multi-layer film according to any one of claims 1 to 5 wherein the film comprises a propylene polymer, optionally wherein the core layer and/or the intermediate layer comprises a propylene homopolymer and/or the first skin layer comprises a propylene/ethylene copolymer and a propylene homopolymer.

7. The multi-layer film according to any one of claims 1 to 6 wherein the first skin layer is corona treated.

8. The multi-layer film according to any one of claims 1 to 7 wherein the film comprises a second skin layer on the opposite side of the film to the first skin layer, with at least one intermediate layer between the second skin layer and the core layer.

9. The multi-layer film according to claim 8 wherein the first skin layer side of the film has a lower gloss than the second skin layer side of the film and/or wherein the first skin layer side of the film has a higher Rz than the second skin layer side of the film.

10. The multi-layer film according to claim 8 or 9 wherein an intermediate layer on the first skin layer side of the film is different to an intermediate layer on the second skin layer side of the film.

11. The multi-layer film according to any one of claims 8 to 10 wherein the intermediate layer between the second skin layer and the core is absent a cavitating agent.

12. The multi-layer film according to any one of claims 1 to 11 wherein the first skin layer side of the film exhibits a gloss (at) 45° of ≤50, optionally ≤45, optionally ≤40, measured in accordance with ASTM D2457.

13. The multi-layer film according to any one of claims 1 to 12 wherein the first skin layer side of the film exhibits a roughness level (Rz) of greater than 3 μm or optionally greater than 4 μm.

14. The multi-layer film according to any one of claims 1 to 13 wherein the high roughness is created by internal roughness, increased surface roughness and/or incompatible polymers in the first skin layer.

15. The multi-layer film according to any one of claims 1 to 14 wherein the at least one intermediate layer comprising the cavitating agent has a density of less than 0.85 g/cm3 and/or wherein the core layer has a density of less than 0.8 g/cm³.

16. The multi-layer film according to any one of claims 1 to 15 wherein the core layer and/or at least one intermediate layer comprises titanium dioxide.

17. A label comprising the multi-layer film according to any one of claims 1 to 16 and an adhesive layer on the first skin layer.

18. The label according to claim 17 wherein the adhesive layer comprises a water-based emulsion, optionally wherein the adhesive is selected from at least one of an acrylic-based adhesive or a vinyl acetate ethylene-based adhesive.

19. An article labelled with the label according to any one of claim 17 or 18.

20. The article according to claim 19 wherein the article is made from a material not present in the label.

21. The article according to claim 19 or claim 20 wherein the article is a bottle.

22. A method for forming a labelled article, comprising:
a) providing an article;
b) providing a label as claimed in any one of claim 17 or 18;
c) arranging the label such that it overlaps with at least a section of the article; and
d) applying pressure to the label such that the film adheres to the article.

23. A method of identifying fibre tear on a labelled article, the method comprising:
a) providing a labelled article according to any one of claims 19 to 21;
b) pulling one side of the label away from the article; and
c) identifying whether fibre tear has occurred.

24. The method according to claim 23 wherein the force required to pull the label from the article is at least 10N.

25. The method according to claim 23 or claim 24 wherein fibre tear is measured using the percentage of the area previously covered by the label on which part of the film remains once the label has been removed and wherein said percentage is greater than 30%, optionally greater than 40%, optionally greater than 50%.
